(19) United States
(12) Patent Application Publication
(10) Pub. No.: US 2017/0089444 A1
(43) Pub. Date: Mar. 30, 2017

(54) PROCESS FOR MAINTAINING A TURBOMACHINE ACCESSORY GEARBOX HOUSING ELEMENT

(71) Applicant: SAFRAN TRANSMISSION SYSTEMS, COLOMBES (FR)

(72) Inventors: Philippe MEUNIER, CORMEILLES EN PARISIS (FR); Laurent HENRY, GRANDFRESNOY (FR); Frederique HUSTACHE, SAINT THIBAUD DES VIGNES (FR)

(21) Appl. No.: 15/315,714

(22) PCT Filed: Jun. 5, 2015
(86) PCT No.: PCT/FR2015/051502

§ 371 Date: Dec. 1, 2016

(30) Foreign Application Priority Data
Jun. 5, 2014 (FR) 1455134

(51) Int. Cl. F16H 57/032; F01D 15/12; C23C 4/134; C23C 4/08; C23C 4/18

(52) U.S. Cl. CPC F16H 57/032; C23C 4/08; C23C 4/18; C23C 4/134; F01D 15/12; F16H 2057/02039

(57) ABSTRACT

The invention proposes a process for maintaining a casting made of magnesium alloy, said casting being a turbomachine accessory gearbox housing or a housing cover, comprising at least one cylindrical surface suitable for receiving a rolling bearing cage, the process being characterized in that it comprises a step (200) that consists in depositing molybdenum on the surface of the casting by plasma spraying.

### FIELD OF THE INVENTION

The field of the invention is that of maintenance of cast parts made of magnesium, in particular casings and casing covers of turbomachine accessory gearboxes.

### PRIOR ART

The turbomachine accessory gearboxes (also called “drive case”) comprise several gear trains for driving various accessory equipments of the aircraft housing the turbomachine.

Each gear train is housed in a bearing cage, in turn mounted on a cylindrical surface of a gearbox casing, and a cover mounted on the casing.

During operation, rotations of gears cause wear by “fretting” (also called contact wear) of the surfaces of the casing and of the cover on which they are mounted, characterized by irregular pitting on the face and diameter of the cylindrical mounting surface. FIG. 1a shows the wear of a bearing cage support of an accessory gearbox casing. Surface fretting of the part is seen at the end of arrow F1, and corrosion craters are indicated by arrow F2.

These degradations disrupt use of gear trains and considerably limit the service life of accessory gearboxes, so it is necessary to repair the casings and the covers.

Current repairs comprise putting a ring in place in lieu and place of the worn cylindrical surfaces to carry the bearing cages and gear trains.

To do this, the degraded surfaces of the casings and covers are machined to eliminate the deformations of fretting (in particular to restore the cylindrical character as fretting causes oval deformation in cross-section on the surface) and to enable insertion of the ring. Machining is carried out on a thickness which can reach 3 mm in radius.

FIG. 1b shows a bearing cage support machined to receive a ring. To the side, another bearing cage support has been repaired by placing a ring.

The ring is stuck onto the machined surface to fasten it to the casing or the cover.

This type of repair is problematic since it is not permanent. In fact, the ring put in place during repair also wears during operation of the gear trains. During the next repair, the ring has to be removed, but also the solidified adhesive, which involves machining an extra thickness of the initial part to reposition a new ring.

Progressive reduction of the thickness of the part by way of machining is such that this type of repair can be made twice only in the life of the part, which is incompatible with prolonged use of accessory gearboxes. So for example, the part illustrated in FIG. 1a can no longer be repaired, as it is evident, at the end of arrow F3, that the minimum surfacing dimension of the part has been reached by previous repairs.

Also, this repair method fails to reinforce the casing or the gearbox cover, because the ring which is used is made of the same metal as the base substrate, i.e., an alloy based on magnesium. Consequently, after repair, the ring wears as fast as the substrate.

There is therefore a need for repairing casings and accessory gearbox covers more permanently by reinforcing during this repair the casing of the relevant gearbox.

### PRESENTATION OF THE INVENTION

The aim of the invention is to propose a process for repairing accessory gearbox casings and covers for reinforcing them and prolonging their service life.

In this respect, the aim of the invention is a process for maintaining a cast part made of magnesium alloy, said part being a casing of a turbomachine accessory gearbox or a casing cover, comprising at least one cylindrical surface capable of receiving a bearing cage, the process being characterized in that it comprises a step of providing a deposit of molybdenum on the surface of the part by plasma spraying.

Advantageously, but optionally, the maintenance process according to the invention can further comprise at least one of the following characteristics:

the part comprises an attached (inserted) ring made of magnesium alloy, said ring comprising a cylindrical surface capable of receiving a bearing cage, and the quantity of molybdenum is deposited onto a surface of said ring.

The process further comprises a preliminary step for machining the deposit surface to remove a thickness of material comprised between 0 and 0.3 mm.

The process comprises the deposit of a thickness comprised between 0.3 and 0.7 mm of molybdenum.

The process further comprises a machining step subsequent to the deposit to remove the surplus of molybdenum from the part.

The magnesium alloy is ZRE1 magnesium or GA6Z1 magnesium. The deposited molybdenum is pure to at least 99%, preferably to at least 99.6%.

Another subject matter of the invention is a magnesium alloy cast part, characterized in that it comprises on a surface at least one area covered with a coating of molybdenum, the part having been replenished by executing the maintenance process presented hereinabove.

Another subject matter of the invention is a turbomachine accessory gearbox, comprising a casing and a cover, the casing and/or the cover being made of magnesium alloy and having been replenished according to the maintenance process presented hereinabove.

Replenishing the casings and covers by a deposit of molybdenum has many advantages. First, this process does not need to hollow out a substantial thickness in the part to position a ring. On the contrary, machining for preparing the surface to the deposit is limited to machining necessary for eliminating traces of fretting. This allows reiterating the process at least seven times on the part before it can no longer be machined.

Also, the resulting part has a hardness greater than the initial part, and therefore exhibits less wear. Repairs can therefore be spaced more over time, which further extends the service life of the part now replenished.

### DESCRIPTION OF THE FIGURES

Other characteristics, aims and advantages of the present invention will emerge from the following detailed description with respect to the appended figures, given by way of non-limiting examples and in which:

FIGS. 1a and 1b, already described, respectively illustrate a casing element worn by fretting and its repair by fixing on a ring,

FIGS. 2a and 2b illustrate a casing of an accessory gearbox and a casing cover,

FIG. 3a illustrates a casing element repaired by the maintenance process according to an embodiment of the invention,

FIG. 3b illustrates a sectional view of a casing element repaired by the maintenance process, at the interface between the magnesium alloy substrate and the deposit of molybdenum.

FIG. 4a schematically illustrates the main steps of the maintenance process,

FIG. 4b schematically illustrates the implementation of the molybdenum deposition step.

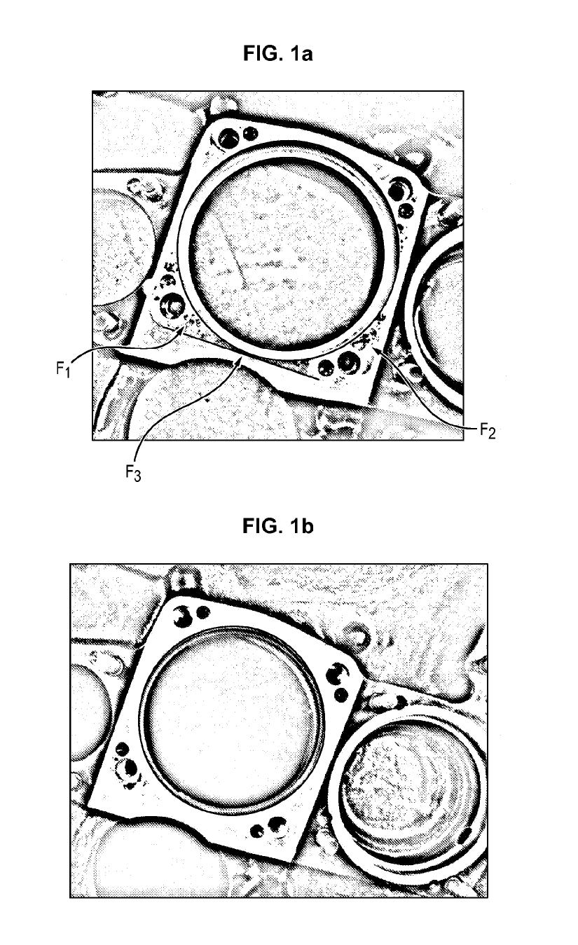

### DETAILED DESCRIPTION OF AT LEAST ONE EMBODIMENT OF THE INVENTION

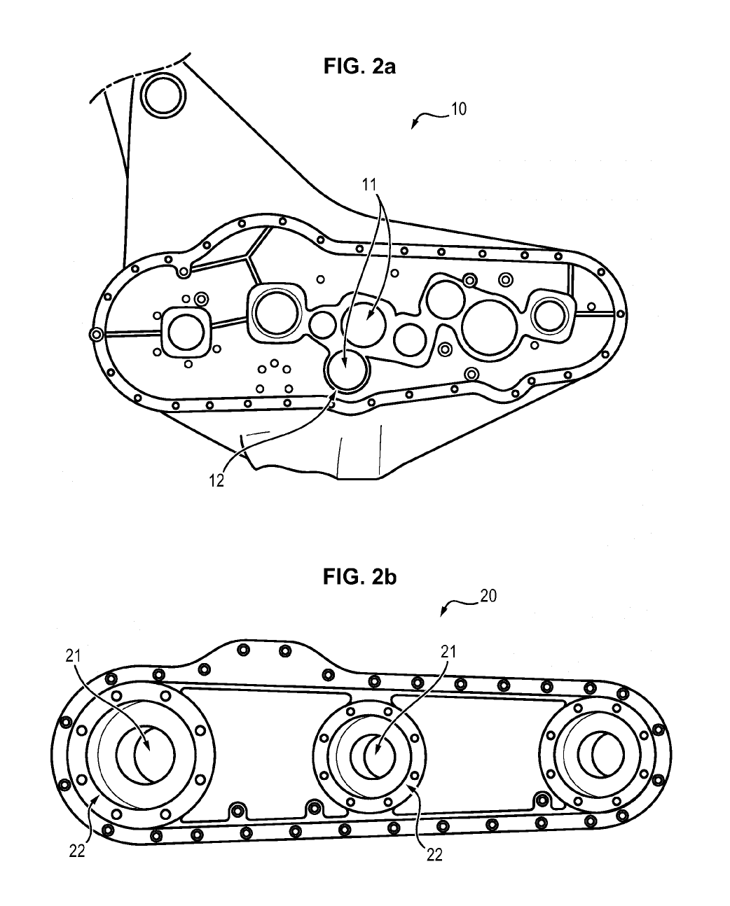

In reference to FIG. 2a, this shows an example of a casing 10 of turbomachine accessory gearboxes. This casing houses a plurality of gear trains (not shown) dedicated to drive accessories of an aircraft in which the accessory gearbox is placed.

In this respect, the casing comprises a plurality of housings 11 adapted to receive a bearing cage of a gear train. Each housing comprises a cylindrical surface 12 capable of receiving said cage. As indicated hereinabove, this surface is worn by fretting during prolonged operation of the gear trains.

Similarly, FIG. 2b shows a cover of an accessory gearbox 20, adapted to be attached on the casing 10 to close the latter. The cover 20 also comprises a plurality of housings 21 each comprising a cylindrical surface 22 capable of receiving a bearing cage of a running train. These surfaces are also subject to wear by fretting during operation of the gear trains.

The accessory gearbox comprises a casing and a cover, the cover being mounted on the casing so as to align the respective housings of the casing and of the cover.

The casing and the cover are cast parts made of magnesium alloy. Advantageously, the magnesium alloy used to melt these parts is ZRE1 alloy, comprising from 2 to 3% by weight of zinc, from 2.5 to 4% by weight of rare earths, from 0.4 to 1% by weight of zirconium, and the balance of magnesium.

So the cylindrical surfaces for receipt of the bearing cages can be formed in this ZRE1 magnesium alloy.

Alternatively, the casing or the cover can have been previously treated by banding as per the process of the prior art explained hereinabove. In this case, the ring 30 is mounted in a housing 11, 21 of the casing or of the cover. The ring comprises a cylindrical surface 32 forming a new support surface of a bearing cage.

This ring 30 can be made of a magnesium alloy other than ZRE1 alloy, advantageously AZ61A alloy, which comprises between 5.8 and 7.2% by weight of aluminium, 0.15% by weight of manganese, from 0.4 to 1.5% by weight of zinc, up to 0.05% by weight of copper, up to 0.05% by weight of nickel, up to 0.05% by weight of silicon, and up to 0.3% by weight of other elements, the balance being magnesium.

The proposed process applies both to cylindrical surfaces 12, 22 receiving bearing cages of the cast parts obtained initially, or to the surface 32 of the rings attached on these parts. Consequently, the cylindrical surfaces treated by the process can be made from ZRE1 alloy or AZ61A alloy.

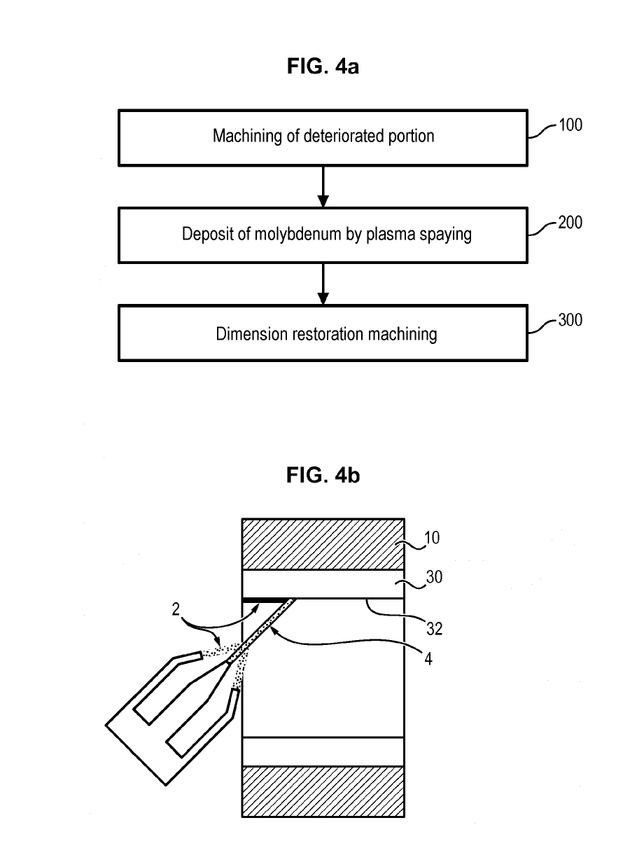

In reference to FIG. 4a, this shows the main steps of a process for maintaining an accessory gearbox casing or a gearbox cover. This process is advantageously implemented to repair a surface 12, 22, 32 of the part degraded by fretting, i.e., advantageously a cylindrical surface for receiving a bearing cage.

This process comprises a first machining step 100 of a reception surface 12, 22, 32 of a bearing cage degraded by fretting, to remove the effects of fretting, i.e., to restore the regularity and cylindrical character of the part. This machining now removes a thickness of material between 0 and 0.3 mm. The machining thickness is not identical over the entire circumference of the surface, since it depends on initial deformation of the part.

The process then comprises a replenishing step 200 of the part, by deposit on the machined surface 12, 22, 32, of molybdenum 2 by plasma spraying. This step 200 is shown schematically in FIG. 4b in the non-limiting example of maintenance of a casing already repaired earlier by placing of a ring 30.

For this to happen, a plasma arc 4 is generated from plasma gases, for example a mix of propane and oxygen, at a voltage of 15 kV, which is used to project molybdenum powder 2 onto the surface 12, 22, 32 to be replenished. On contact with the plasma arc the powder melts and creates a uniform coating on the surface which solidifies when cooled.

The molybdenum deposited is advantageously pure, i.e., the material deposited comprises at least 99%, and preferably at least 99.6% of molybdenum.

The spraying distance is between 40 and 50 cm, advantageously equal to 45 cm. The part is fixed and centered at the cylindrical surface 12, 22, 32 to be replenished on a revolving plate driven in rotation by a motor. Coolers positioned at the periphery of the part ensure that its temperature is constant and close to ambient temperature to avoid the deformations of the part or alterations of its mechanical characteristics.

The quantity of molybdenum deposited must be sufficient to restore the initial dimension of the part for receiving the bearing cages, i.e., it must at least compensate the machining carried out at step 100, and the wear of the part. Advantageously, during this step 200 a thickness of molybdenum deposited is between 0.3 and 0.7 mm, and preferably equal to 0.5 mm.

The process finally comprises a novel machining step 300 of the part to remove the surplus of molybdenum deposited and confer on the now replenished part its initial dimensions to allow a bearing cage to be repositioned there. This machining is therefore performed on a thickness which can be variable, as a function of the deposit thickness of molybdenum. But it is preferably less than 0.3 mm in radius.

The final deposit on the part has a thickness of the order of 0.2 mm.

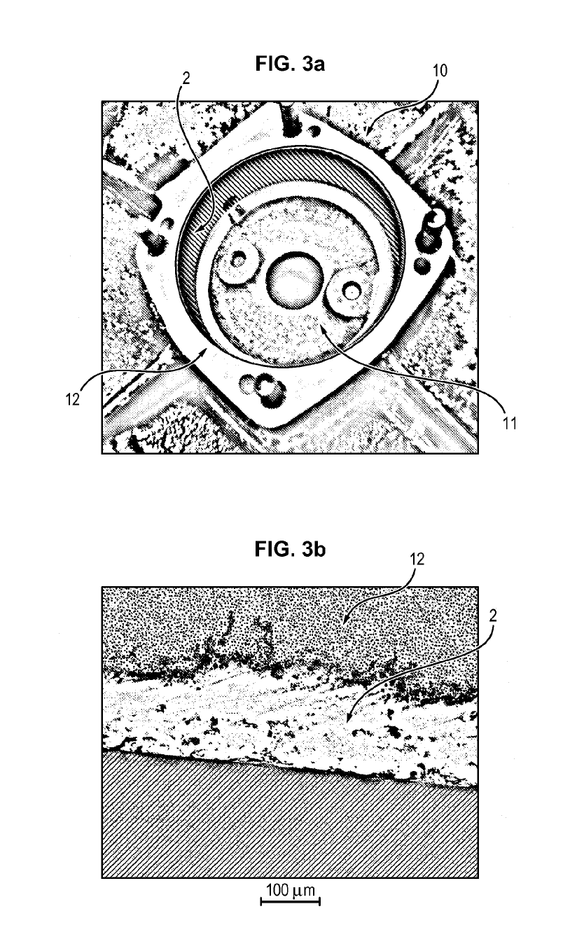

FIG. 3a shows a part 10 replenished by the process described previously. It comprises the housing 11 comprising the cylindrical deposit surface of molybdenum, and the deposit 2 on said surface. This process is very advantageous, since it can be renewed at least 8 or even 10 times on the part, in contrast to the process of the prior art which could be renewed twice only.

In particular, this process can be implemented on a part already repaired by addition of a ring, and does not need the ring to be withdrawn and the additional machining to remove the solidified adhesive, but machining limited in thickness.

Also, tests conducted on parts replenished in this way show clear improvement in their hardness; in fact, the ZRE1 magnesium alloy from which the cover or the base casing is made has a hardness of around 48 HB, while the molybdenum deposited on this alloy has a hardness of 132 HB.

The replenished part also produces a suitable result during dye penetrant testing of level S4.

Finally FIG. 3b shows, enlarged 200 times by microscope, the interface between the deposit 2 of molybdenum and the substrate 12 made of magnesium alloy. Good molecular cohesion is evident at this site between the deposit of molybdenum and the substrate made of magnesium. This cutting notes the quality of the deposit (absence of inclusions or cracking) and the adhesion of the latter (no delamination apparent in magnification ×200).

1. A process for maintaining a cast part made of magnesium alloy, said part being a casing of a turbomachine accessory gearbox or a casing cover, comprising at least one cylindrical surface capable of receiving a bearing cage, the process being characterized in that wherein it comprises a step of providing a deposit of molybdenum on the surface of the part by plasma spraying.

2. The maintenance process according to claim 1, wherein the part comprises an attached ring made of magnesium alloy, said ring comprising a cylindrical surface capable of receiving a bearing cage, and the quantity of molybdenum is deposited onto a surface of said ring.

3. The maintenance process according to claim 1, further comprising a preliminary step for machining the deposit surface to remove a thickness of material comprised between 0 and 0.3 mm.

4. The maintenance process according to claim 1, further comprising a deposit of a thickness comprised between 0.3 and 0.7 mm of molybdenum.

5. The maintenance process according to claim 1, further comprising a machining step subsequent to the deposit to remove the surplus of molybdenum from the part.

6. The maintenance process according to claim 1, wherein the magnesium alloy is ZRE1 magnesium or GA6Z1 magnesium.

7. The maintenance process according to claim 1, wherein the molybdenum deposited is pure to at least 99%, preferably to at least 99.6%.

8. A cast part made of magnesium alloy, characterized in that it comprising on a surface at least one area covered with a coating of

8. A cast part made of magnesium alloy, comprising on a surface at least one area covered with a coating of molybdenum, said part having been replenished by executing the process according to claim 1.

9. A turbomachine accessory gearbox, comprising a casing and a cover, the casing and/or the cover being made of magnesium alloy and having been replenished according to the process according to claim 1.
